(19) United States
(12) Patent Application Publication
(10) Pub. No.: US 2005/0036855 A1
(43) Pub. Date: Feb. 17, 2005

(54) Robot blade for handling of semiconductor waffers

(75) Inventor: Martin B. Garcia JR., Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/640,121

(22) Filed: Aug. 13, 2003

(51) Int. Cl. B65G 49/07

(52) U.S. Cl. 414/217

(57) ABSTRACT

According to one embodiment of the invention, a system for handling semiconductor wafers includes a chamber, a robot associated with the chamber, and a robot blade generally horizontally disposed within the chamber and coupled to the robot at a first end. The robot blade includes a second end distal the first end, in which the second end has a plan view profile that forms a continuously curved surface.

### TECHNICAL FIELD OF THE INVENTION

The present invention relates generally to semiconductor wafer processing and, more particularly, to a robot blade for handling of semiconductor wafers.

### BACKGROUND OF THE INVENTION

Semiconductor wafers are subjected to many different processes in order to manufacture semiconductor die on the wafer. Semiconductor wafers are typically transferred between processing chambers in order to carry out the different processes. For efficiency purposes, a robot is used to transfer the wafers between chambers. A robot blade associated with the robot, sometimes referred to as an end effector, is used to transfer individual wafers. Depending on the process chamber that the robot blade is transferring the semiconductor wafer to, the robot blade may see temperature fluctuations.

Current robot blades have distal ends (the ends that are proximate the semiconductor wafers during transferring) that have straight edges that result in sharp corners (approximately 90 degrees). Over a period of time these sharp corners deteriorate by peeling, chipping, delaminating, or other type of deterioration. The deterioration causes particles from the robot blade material to imbed in or attach to the semiconductor wafer that it is transferring, which causes all or a portion of the wafer to be defective. Thus, yield is severely degraded, which wastes considerable time and money.

### SUMMARY OF THE INVENTION

According to one embodiment of the invention, a system for handling semiconductor wafers includes a chamber, a robot associated with the chamber, and a robot blade generally horizontally disposed within the chamber and coupled to the robot at a first end. The robot blade includes a second end distal the first end, in which the second end has a plan view profile that forms a continuously curved surface.

Embodiments of the invention provide a number of technical advantages. Embodiments of the invention may include all, some, or none of these advantages. In one embodiment, a robot blade utilized for transferring semiconductor wafers in a transfer chamber includes rounded edges at its distal end that eliminates deterioration of any portion of the distal end due to thermal cycling or other factors. This assures that no particles associated with the robot blade material get embedded in the semiconductor wafer that the robot blade is handling or fall onto a lower semiconductor wafer, which may cause defective wafers. In addition, wafer breakage may be avoided by preventing any delamination or peeling of the distal end of the robot blade. Reducing defects in, or breakage of, semiconductor wafers during their handling greatly improves yield, which saves considerable time and money.

Other technical advantages are readily apparent to one skilled in the art from the following figures, descriptions, and claims.

### BRIEF DESCRIPTION OF THE DRAWINGS

For a more complete understanding of the present invention and its advantages, reference is now made to the following descriptions, taken in conjunction with the accompanying drawings, in which:

FIG. 1 is a partial plan view of a wafer processing system in accordance with one embodiment of the present invention;

FIG. 2A is a partial plan view of a conventional robot blade;

FIG. 2B is a partial plan view of a robot blade in accordance with one embodiment of the present invention; and

FIG. 2C is a partial plan view of a robot blade in accordance with one embodiment of the present invention.

### DETAILED DESCRIPTION OF EXAMPLE EMBODIMENTS OF THE INVENTION

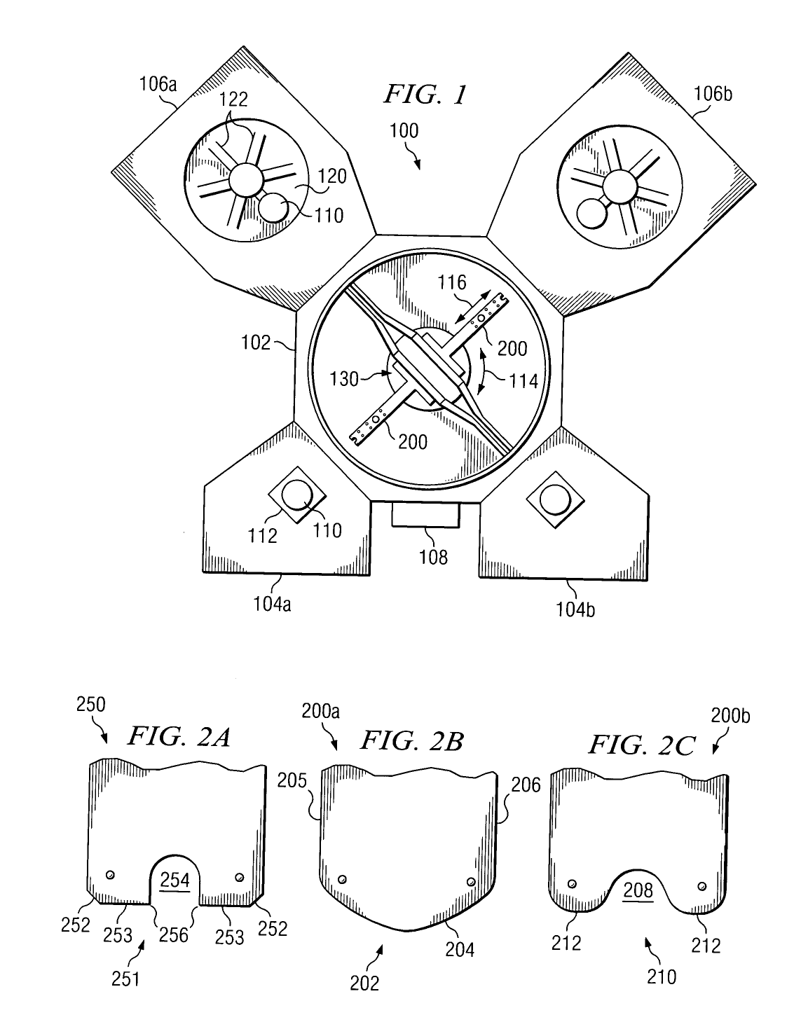

Example embodiments of the present invention and their advantages are best understood by referring now to FIGS. 1 and 2C of the drawings, in which like numerals refer to like parts.

FIG. 1 is a partial plan view of a wafer processing system 100 in accordance with one embodiment of the present invention. Processing system 100 generally represents the SEQUEL family of processing systems manufactured by Novellus Systems, Inc.; however, other suitable processing systems are contemplated by the present invention. In the illustrated embodiment, processing system 100 includes a transfer chamber 102 disposed between a pair of load locks 104a, 104b and a pair of process chambers 106a, 106b. Processing system 100 also includes a cool station 108.

Transfer chamber 102 includes a pair of robot blades 200 (also known as end effectors) that function to transfer semiconductor wafers 110 or other suitable substrates within processing system 100. Accordingly, robot blades 200 are able to rotate within transfer chamber 102, as denoted by double-headed arrow 114, and are able to translate in and out, as denoted by double-headed arrow 116. Any suitable system that allows robot blades 200 to rotate and translate is contemplated by the present invention. In the illustrated embodiment, a robot 130 associated with processing system 100 is utilized. Details of various embodiments of robot blade 200 are described below in conjunction with FIGS. 2B and 2C.

Load locks 104a, 104b function to house a plurality of one or more semiconductor wafers 110, which are typically disposed within a boat 112. Individual semiconductor wafers 110 sit in boat 112 and wait to be picked up and transferred by a particular robot blade 200. As illustrated in FIG. 1, a particular semiconductor wafer 110 has already been transferred to process chamber 106a.

Process chambers 106a, 106b, function to process semiconductor wafers 110. Any suitable processing, such as vapor deposition, may be carried out in process chambers 106a, 106b. In the illustrated embodiment, process chamber 106a includes a heating block 120 and a plurality of ceramic forks 122. Heating block 120 functions to heat semiconductor wafers 110 to an elevated temperature for processing and ceramic forks 120 function to allow robot blades 200 to deliver and remove semiconductor wafers 110 from heating block 120. Typically, heating block 120 is at a temperature in the range of approximately 350 to 400° C.; however, the temperature of heating block 120 may be any suitable temperature depending on the recipe or process.

Because of the nature of semiconductor processing, it is desirable for semiconductor wafer processors to avoid defects within semiconductor wafers 110. Even the most minute of foreign material or other defect with respect to semiconductor wafers 110 may ruin all or a portion of a particular semiconductor wafer 100. Reducing defects in or breakage of semiconductor wafers 100 during their handling and/or processing greatly improves yield, which saves considerable time and money.

Before the invention described herein, many defective particles were discovered in semiconductor wafers in a processing system similar to processing system 100 of FIG. 1. One reason for these defective particles was the shape of the robot blade being used in those prior systems. Such a robot blade is shown and described in conjunction with FIG. 2A.

FIG. 2A is a partial plan view of a conventional robot blade 250. A distal end 251 of robot blade 250 is defined by a pair of chamfers 252 at the outer corners thereof, a pair of straight edges 253, and a notch 254 generally positioned in the center of robot blade 250. Straight edges 253 and notch 254 define a pair of corners 256. Corners 256 are at typically at ninety degree angles; however, corners 256 may also be at forty-five degree angles. It is these corners 256 that have provided problems with robot blade 250 in that deterioration occurs at corners 256 due to the temperature cycling that robot blade 250 encounters from the transfer of semiconductor wafers 110 to and from heater block 120. Deterioration of corners 256, such as peeling, chipping, delamination and other types of material degradation result in small particles being imbedded in or attaching to all or a portion of semiconductor wafers 110, which causes defects in the wafers. Depending on the type of defect, it may also cause breakage of semiconductor wafer 100. Typically, the size of the particles that have been found to cause defective semiconductor wafers 110 are between 0.5 to ten microns and the composition of such particles range anywhere from molybdenum, cobalt, iron, chromium, nickel, magnesium, silicon, and other suitable particles. The type of particles depends upon the type of material that robot blade 250 is formed from.

One reason for the deterioration of corners 256 is that there is less heat sink proximate corners 256. Therefore, according to the teachings of one embodiment of the present invention, new robot blades have been designed that increase the heat sinks at the distal ends of the robot blades to eliminate deterioration of any portion of the distal ends of the robot blades. This substantially reduces or eliminates the risk of having defective particles associated with the semiconductor wafers, which greatly improves yield. Various embodiments of the new robot blades are illustrated below in conjunction with FIGS. 2B and 2C.

FIG. 2B is a partial plan view of a robot blade 200a in accordance with one embodiment of the present invention. Robot blade 200a may be formed from any suitable material; however, in a particular embodiment, robot blade 200a is formed from molybdenum. Although not illustrated in FIG. 2B, robot blade 200a may have any suitable thickness. In addition, with reference to FIG. 1, robot blade 200a is integrally formed from one piece of material. In other words, robot blade 200a is a one-piece robot blade, devoid of any gaskets or other parts, that couples to any suitable robot within transfer chamber 102.

Robot blade 200a has a distal end 202 that avoids the problems associated with prior robot blades, such as robot blade 250 as described in FIG. 2A. In the illustrated embodiment, distal end 202 has a plan view profile (i.e., a profile as viewed from the top) that forms a continuously curved surface 204 extending between a first side 205 and a second side 206 of robot blade 200a. First side 205 and second side 206 are straight-edged sides of robot blade 200a that are substantially parallel to one another. Continuously curved surface 204 may be convex or concave with respect to first side 205 and second side 206 and may have any suitable curved shape, such as circular, elliptical, semi-elliptical, parabolic, hyperbolic, arcuate, catenary, or other suitable curvilinear shape. Continuously curved surface 204 is devoid of any sharp corners as in prior robot blades that would cause deterioration of distal end 202.

FIG. 2C is a partial plan view of a robot blade 200b in accordance with another embodiment of the present invention. Similar to robot blade 200a, robot blade 200b may be formed from any suitable material and have any suitable thickness. One difference between robot blade 200a and robot blade 200b is that robot blade 200b has an alignment notch 208 formed in a distal end 210. Alignment notch 208, which may also act as a scanning gap, may have any suitable size and any suitable shape. In one embodiment, a plan view profile of notch 208 forms a suitably curved surface, such as circular, elliptical, semi-elliptical, parabolic, hyperbolic, arcuate, catenary, or other suitable curvilinear shape As a result of notch 208, a pair of protrusions 212 exist at distal end 210. Protrusions 212 may also have any suitable size and shape; however, it is preferred that a plan view profile of protrusions 212 be formed from a continuously curved surface, such as circular, elliptical, semi-elliptical, parabolic, hyperbolic, arcuate, catenary, or other suitable curvilinear shape. In a particular embodiment of the present invention, the plan view profile of distal end 210 of robot blade 200b, which is defined by the plan view profiles of protrusions 212 and alignment notch 208 form a generally sinusoidal shape.

In one embodiment of the invention, robot blade 200a and robot blade 200b are designed for transferring semiconductor wafers 100 between an ambient temperature environment and an elevated temperature environment. For example, referring to FIG. 1, processing system 100 may be a suitable chemical vapor deposition processing system in which semiconductor wafers 110 are transferred from boat 112, which is at approximately ambient temperature, to processing chamber 106a having heating block 120, which is at an elevated temperature, such as approximately 400° C. In other embodiments, robot blades 200a, 200b are designed for other suitable processing systems. In addition, in one embodiment of the invention, both robot blades 200a and 200b are devoid of any vacuum ports.

Although embodiments of the invention and their advantages are described in detail, a person skilled in the art could make various alterations, additions, and omissions without departing from the spirit and scope of the present invention as defined by the appended claims.

1. A system for handling semiconductor wafers, comprising:
a chamber;
a robot associated with the chamber; and
a robot blade generally horizontally disposed within the chamber and coupled to the robot at a first end, the robot blade comprising a second end distal the first end, the second end having a plan view profile that forms a continuously curved concave surface.

2. The system of claim 1, wherein the second end extends from a first side to a second side of the robot blade, the first and second sides substantially parallel.

3. (cancelled)

4. The system of claim 1, further comprising a notch formed in the distal end, the notch also having a plan view profile that forms a continuously curved surface.

5. The system of claim 1, wherein the robot blade is integrally formed from one piece of material.

6. The system of claim 1, wherein the continuously curved surface is formed from one or more curved shapes selected from the group consisting of circular, elliptical, semi-elliptical, parabolic, hyperbolic, arcuate, and catenary.

7. The system of claim 1, further comprising a load lock at a first temperature approximately equal to ambient temperature and a processing chamber having a heating block at an elevated temperature, wherein the robot is operable to direct the robot blade to transfer semiconductor wafers from the load lock to the heating block.

8. The system of claim 7, wherein the elevated temperature is between approximately 350° C. and approximately 400° C.

9. A system for handling semiconductor wafers, comprising:
a chamber;
a robot associated with the chamber; and
a robot blade generally horizontally disposed within the chamber and coupled to the robot at a first end, the robot blade comprising a second end distal the first end, and first and second generally parallel sides, the second end extending from the first side to the second side and comprising:
a notch having a generally concave surface with respect to the first and second sides;
a pair of protrusions each having a generally concave surface with respect to the first and second sides; and
wherein a plan view profile of the notch and pair of protrusions form a continuously curved surface from the first side to the second side.

10. The system of claim 9, wherein the concave surface of the notch is formed from one or more curved shapes selected from the group consisting of circular, elliptical, semi-elliptical, parabolic, hyperbolic, arcuate, and catenary.

11. The system of claim 9, wherein the concave surfaces of the pair of protrusions are formed from one or more curved shapes selected from the group consisting of circular, elliptical, semi-elliptical, parabolic, hyperbolic, arcuate, and catenary.

12. The system of claim 9, wherein the robot blade is integrally formed from one piece of material.

13. The system of claim 9, wherein the robot blade is devoid of any vacuum ports.

14. The system of claim 9, further comprising a load lock at a first temperature approximately equal to ambient temperature and a processing chamber having a heating block at an elevated temperature, wherein the robot is operable to direct the robot blade to transfer semiconductor wafers from the load lock to the heating block.

15. The system of claim 14, wherein the elevated temperature is between approximately 350° C. and approximately 400° C.

16. (cancelled):

17. (cancelled):

18. (cancelled):

19. (cancelled):

20. (cancelled):
